(19) United States
(12) Patent Application Publication
(10) Pub. No.: US 2024/0176309 A1
(43) Pub. Date: May 30, 2024

(54) MACHINE LEARNING DEVICE, ACCELERATION AND DECELERATION ADJUSTMENT DEVICE, AND COMPUTER-READABLE STORAGE MEDIUM

(71) Applicant: FANUC CORPORATION, Yamanashi (JP)

(72) Inventors: Shunsuke AOKI, Yamanashi (JP); Nobuaki AIZAWA, Yamanashi (JP)

(21) Appl. No.: 18/551,192

(22) PCT Filed: Apr. 23, 2021
(86) PCT No.: PCT/JP2021/016479

§ 371 Date: Sep. 19, 2023

(51) Int. Cl. G05B 13/02

(52) U.S. Cl. CPC G05B 13/0265

(57) ABSTRACT

A machine learning device that estimates parameters that relate to the control of the movement amount in each control cycle and include Nth-order time differential elements of each axis of a machine tool that machines workpieces, the machine learning device comprising: a state observation unit that observes data indicating the movement state of the machine tool; a determination condition acquisition unit that acquires, as determination data, target values relating to the data observed by the state observation unit; a reward calculation unit that calculates, on the basis of the state data and the determination data, rewards associated with machining based on the parameters; a value function update unit that updates value functions on the basis of the rewards; and a decision-making unit that estimates, on the basis of the value functions, combinations of set values of the parameters that are more suitable for the machining, and outputs said combinations.

### TECHNICAL FIELD

The present invention relates to a machine learning device, an acceleration/deceleration adjustment device, and a computer-readable storage medium.

### BACKGROUND ART

A workpiece is machined by controlling a machine tool based on a machining program, and a product such as a part or a mold is manufactured. A machining speed for machining the workpiece is commanded as a movement speed of a shaft in the machining program. The movement speed of the shaft commanded in the machining program is the maximum speed of relative movement (tool movement) between a tool and the workpiece. The machine tool varies the movement speed of the shaft according to a parameter related to control of each shaft at start of machining, a corner, a curved part, etc., within a range not exceeding the commanded maximum speed.

In manufacturing a product, a target tolerance and machined surface quality are set in advance. In addition, a target machining time is determined in advance. An operator of the machine tool adjusts a parameter such as an acceleration/deceleration time constant and adjusts the movement speed commanded in the machining program while checking a machining error and machined surface quality of the product after machining.

As conventional technology for adjusting a parameter related to control of each shaft in machining of a product, a patent application has been filed in which machine learning technology is used to obtain the optimal speed distribution that balances between a machining error or machined surface quality and a machining time (for example, see Patent Document 1).

### CITATION LIST

### Patent Document

Patent Document 1: JP 2017-068325 A

### SUMMARY OF THE INVENTION

### Problem to be Solved by the Invention

When data related to a speed distribution is used as a criterion for parameter adjustment, it is necessary to designate thresholds for acceleration, jerk, etc., which are used as the criterion. However, unless it is known how to set the thresholds and what degrees of machining error and machined surface quality are obtained accordingly, it is difficult to quantitatively control the target tolerance and machined surface quality.

In addition, an appropriate speed distribution is set in accordance with a predetermined machining purpose in a predetermined machine tool. For this reason, there is a problem in that it is necessary to reset the appropriate speed distribution each time the machine tool for performing machining is changed or the machining purpose is changed.

For this reason, there is needed technology capable of adjusting a parameter in machining based on a criterion other than the speed distribution.

### Means for Solving Problem

An acceleration/deceleration adjustment device according to the present disclosure solves the above problems by directly designating a permissible machining error such as a shape error or a positional deviation and machined surface quality to enable quantitative control. The acceleration/deceleration adjustment device according to the disclosure introduces machine learning that optimizes a combination of set values of parameters for controlling the amount of movement of each shaft for each control cycle, including an N-order time differential element (N being a natural number) of a speed of each shaft.

Further, an aspect of the disclosure is a machine learning device for estimating parameters related to control of an amount of movement for each control cycle, including an N-order time differential element (N being a natural number) of each shaft included in a machine tool for performing machining of a workpiece, the machine learning device including a state observer configured to observe information related to at least one of machining accuracy or machined surface quality in the machining and a machining time consumed for the machining as data indicating an operating state of the machine tool, a determination condition acquirer configured to acquire a target value related to data observed by the state observer as determination data, a reward calculation unit configured to calculate a reward for machining based on the parameters based on data observed by the state observer and the determination data acquired by the determination condition acquirer, a value function update unit configured to update a value function for calculating a value of a machining state based on the parameters based on the reward, and a decision maker configured to estimate a combination of set values of the parameters more suitable for the machining based on the updated value function, and output the estimated combination of the set values of the parameters.

Another aspect of the disclosure is an acceleration/deceleration adjustment device for adjusting parameters related to control of an amount of movement for each control cycle, including an N-order time differential element (N being a natural number) of each shaft included in a machine tool for performing machining of a workpiece, the acceleration/deceleration adjustment device including a state observer configured to observe information related to at least one of machining accuracy or machined surface quality in the machining and a machining time consumed for the machining as data indicating an operating state of the machine tool, a determination condition acquirer configured to acquire a target value related to data observed by the state observer as determination data, a value function storage unit configured to store a value function for calculating a value of a machining state based on the parameters, a decision maker configured to estimate a combination of set values of the parameters more suitable for the machining based on the value function, and output the estimated combination of the set values of the parameters, and an action output unit configured to adjust the parameters of the machine tool based on a combination of set values of the parameters output by the decision maker.

Still another aspect of the disclosure is a computer-readable storage medium storing a program causing a computer to operate as a machine learning device for estimating parameters related to control of an amount of movement for each control cycle, including an N-order time differential element (N being a natural number) of each shaft included in a machine tool for performing machining of a workpiece, the computer-readable storage medium storing a program causing the computer to operate as a state observer configured to observe information related to at least one of machining accuracy or machined surface quality in the machining and a machining time consumed for the machining as data indicating an operating state of the machine tool, a determination condition acquirer configured to acquire a target value related to data observed by the state observer as determination data, a reward calculation unit configured to calculate a reward for machining based on the parameters based on data observed by the state observer and the determination data acquired by the determination condition acquirer, a value function update unit configured to update a value function for calculating a value of a machining state based on the parameters based on the reward, and a decision maker configured to estimate a combination of set values of the parameters more suitable for the machining based on the updated value function, and output the estimated combination of the set values of the parameters.

Yet another aspect of the disclosure is a computer-readable storage medium storing a program causing a computer to operate as an acceleration/deceleration adjustment device for adjusting parameters related to control of an amount of movement for each control cycle, including an N-order time differential element (N being a natural number) of each shaft included in a machine tool for performing machining of a workpiece, the computer-readable storage medium storing a program causing the computer to operate as a state observer configured to observe information related to at least one of machining accuracy or machined surface quality in the machining and a machining time consumed for the machining as data indicating an operating state of the machine tool, a determination condition acquirer configured to acquire a target value related to data observed by the state observer as determination data, a value function storage unit configured to store a value function for calculating a value of a machining state based on the parameters, a decision maker configured to estimate a combination of set values of the parameters more suitable for the machining based on the value function, and output the estimated combination of the set values of the parameters, and an action output unit configured to adjust the parameters of the machine tool based on a combination of set values of the parameters output by the decision maker.

### Advantageous Effects of the Invention

According to an aspect of the disclosure, by setting target values (shape error, positional deviation, etc.) for actual machining accuracy or machined surface quality, adjustment to suitable parameters becomes possible, and thus quantitative control of the machining accuracy/machined surface quality becomes possible.

### BRIEF DESCRIPTION OF DRAWINGS

FIG. 1 is a hardware configuration diagram of an acceleration/deceleration adjustment device;

FIG. 2 is a block diagram depicting functions of the acceleration/deceleration adjustment device;

FIG. 3 is a diagram for illustrating calculation of machining accuracy;

FIG. 4 is a diagram for illustrating calculation of machined surface quality;

FIG. 5 is a flowchart showing a schematic operation example of the acceleration/deceleration adjustment device;

FIG. 6 is a diagram for illustrating adjustment of parameters; and

FIG. 7 is a block diagram depicting functions of an acceleration/deceleration adjustment device according to another embodiment.

### MODE (S) FOR CARRYING OUT THE INVENTION

Hereinafter, embodiments of the invention will be described with reference to the drawings.

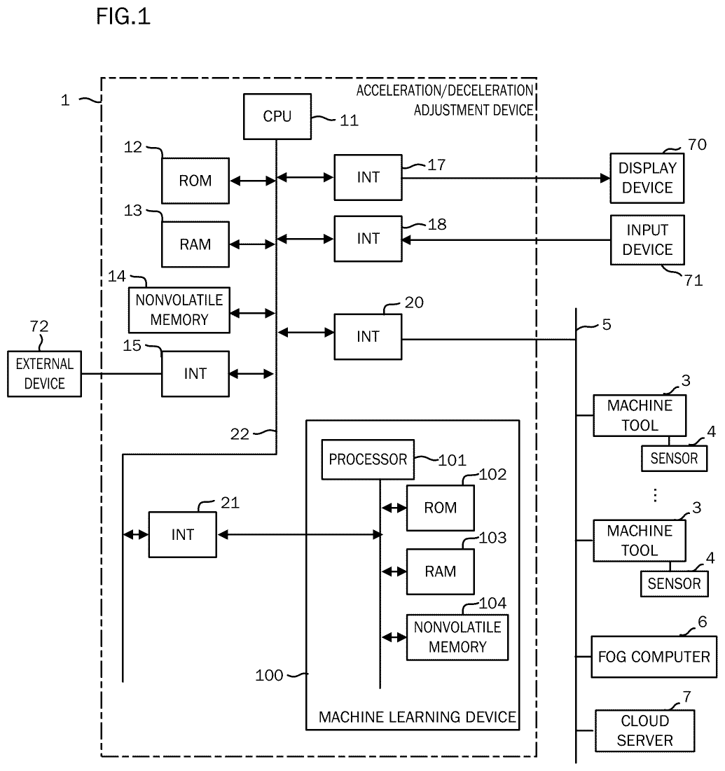

FIG. 1 is a schematic hardware configuration diagram illustrating the main part of an acceleration/deceleration adjustment device according to an embodiment of the invention. The acceleration/deceleration adjustment device 1 of the invention can be mounted, for example, as a controller for controlling a machine tool based on a machining program. In addition, the acceleration/deceleration adjustment device 1 of the invention can be mounted on a personal computer installed side by side with a controller for controlling a machine tool based on a machining program, or on a computer such as a personal computer, a cell computer, a fog computer 6, or a cloud server 7 connected to the controller via a wired/wireless network. The present embodiment illustrates an example in which the acceleration/deceleration adjustment device 1 is mounted on the personal computer connected to the controller for controlling the machine tool via the network.

A CPU included in the acceleration/deceleration adjustment device 1 according to the present embodiment is a processor for controlling the entire acceleration/deceleration adjustment device 1. The CPU 11 reads a system program stored in a ROM 12 via a bus 22 and controls the entire acceleration/deceleration adjustment device 1 according to the system program. Temporary calculation data and display data, various data input from the outside, and so on are temporarily stored in a RAM 13.

A nonvolatile memory 14 includes, for example, a memory backed up by a battery, not shown, a solid state drive (SSD), and so on, and retains a storage state even when power of the acceleration/deceleration adjustment device 1 is turned off. The nonvolatile memory 14 stores data read from an external device 72 via an interface 15, data input via an input device 71, data obtained from a machine tool 3 (including data detected by a sensor 4), etc. The data stored in the nonvolatile memory 14 may be loaded in the RAM 13 during execution or use. In addition, various system programs such as a well-known analysis program are written to the ROM 12 in advance.

The sensor 4 is attached to the machine tool 3 to detect physical quantities such as current, voltage, and vibration of each part during operation of the machine tool 3. Examples of the machine tool 3 include a machining center and a lathe. In response to a request from the acceleration/deceleration adjustment device 1, the machine tool 3 transmits data such as position, speed, acceleration, jerk, vibration, and machining time of each shaft during machining via a network 5.

The interface 15 is an interface for connecting the CPU 11 in the acceleration/deceleration adjustment device 1 and the external device 72 such as a USB device to each other. For example, a pre-stored machining program, data related to operation of each machine tool 3, etc. can be read from the side where the external device 72 is arranged. In addition, a machining program, setting data, etc. edited in the acceleration/deceleration adjustment device 1 can be stored in an external storage means via the external device 72.

An interface 20 is an interface for connecting the CPU in the acceleration/deceleration adjustment device 1 and the wired or wireless network 5 to each other. The machine tool 3, the fog computer 6, the cloud server 7, etc. are connected to the network 5 to exchange data with the acceleration/deceleration adjustment device 1.

Various data read on the memory, data obtained as a result of executing a program or the like, data output from a machine learning device 100, which will be described later, and so on are output to a display device 70 via an interface 17 and displayed thereon. In addition, the input device 71 including a keyboard, a pointing device, and so on delivers a command based on an operation by an operator, data, and so on via an interface 18 to the CPU 11.

An interface 21 is an interface for connecting the CPU 11 and the machine learning device 100 to each other. The machine learning device 100 includes a processor 101 for controlling the entire machine learning device 100, a ROM 102 that stores a system program, etc., a RAM 103 for performing temporary storage in each process related to machine learning, and a nonvolatile memory 104 used in storage of a model or the like. The machine learning device 100 can observe each piece of information (for example, data detected during machining by the machine tool 3) acquirable by the acceleration/deceleration adjustment device 1 via the interface 21. In addition, the acceleration/deceleration adjustment device 1 acquires a processing result output from the machine learning device 100 via the interface 21, and stores or displays the acquired result or transmits the acquired result via the network 5 or the like to another device.

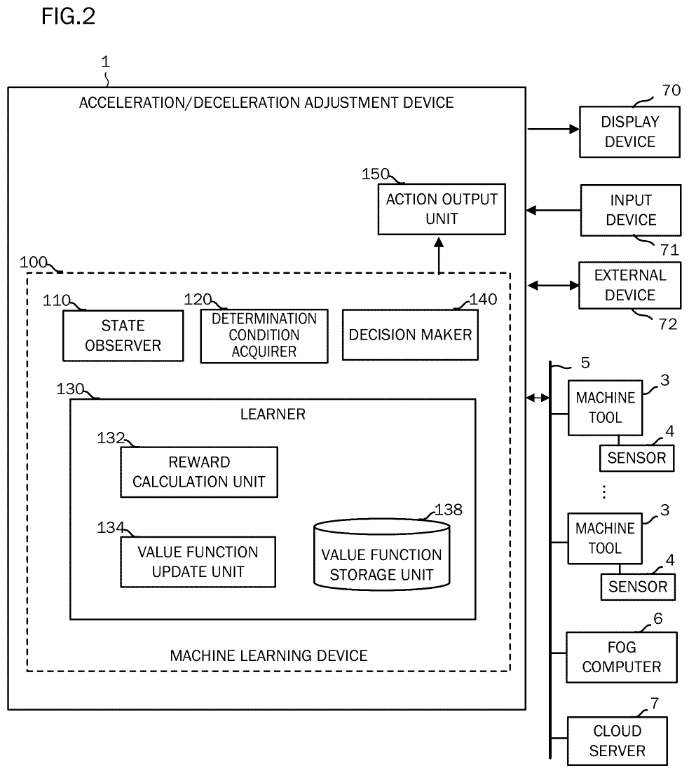

FIG. 2 illustrates functions included in the acceleration/deceleration adjustment device 1 according to a first embodiment of the invention as a schematic block diagram. Each of the functions included in the acceleration/deceleration adjustment device 1 according to the present embodiment is actualized by the CPU 11 included in the acceleration/deceleration adjustment device 1 and the processor 101 included in the machine learning device 100 shown in FIG. 1 executing a system program and controlling an operation of each component of the acceleration/deceleration adjustment device 1 and the machine learning device 100.

The acceleration/deceleration adjustment device 1 of the present embodiment includes a state observer 110, a determination condition acquirer 120, and an action output unit 150. In addition, the machine learning device 100 in the acceleration/deceleration adjustment device 1 includes a learner 130 and a decision maker 140. Furthermore, a value function storage unit 138 that stores a value function serving as a result of machine learning by a learner 130 is prepared in advance on the RAM 103 and the nonvolatile memory 104 in the machine learning device 100.

The state observer 110 observes information related to at least one of machining accuracy or machined surface quality, and a machining time as data indicating an operating state of the machine tool. Observing here means acquiring data from an environment and calculating predetermined data based on the acquired data. First, the state observer 110 acquires various data detected during operation of the machine tool 3 as data indicating an operating state of machining by the machine tool 3. The state observer 110 acquires, for example, position, speed, acceleration, jerk, vibration, and machining time of each shaft during machining in the machine tool 3 as data indicating the operating state of machining by the machine tool 3. In addition, the state observer 110 acquires parameters (linear acceleration, linear jerk, post-interpolation acceleration/deceleration time constant, corner speed difference, position loop gain, feedforward coefficient, etc.) related to control of the amount of movement for each control cycle, including an N-order time differential element (N being a natural number) of each shaft set during machining of the machine tool 3, or a machining program used in machining control as data indicating the operating state of machining by the machine tool 3. The data acquired by the state observer 110 may be instantaneous values acquired at predetermined timing. Moreover, the data acquired by the state observer 110 may be time-series data and so on acquired over a predetermined time.

Further, the state observer 110 calculates data related to machining accuracy or machined surface quality in the machining based on position data, speed data, acceleration data, jerk data, vibration data, etc. of each shaft included in the data indicating the operating state of machining by the machine tool 3. As examples of the calculated data related to the machining accuracy or the machined surface quality, a shape error, a positional deviation, a vibration error, and so on are illustrated.

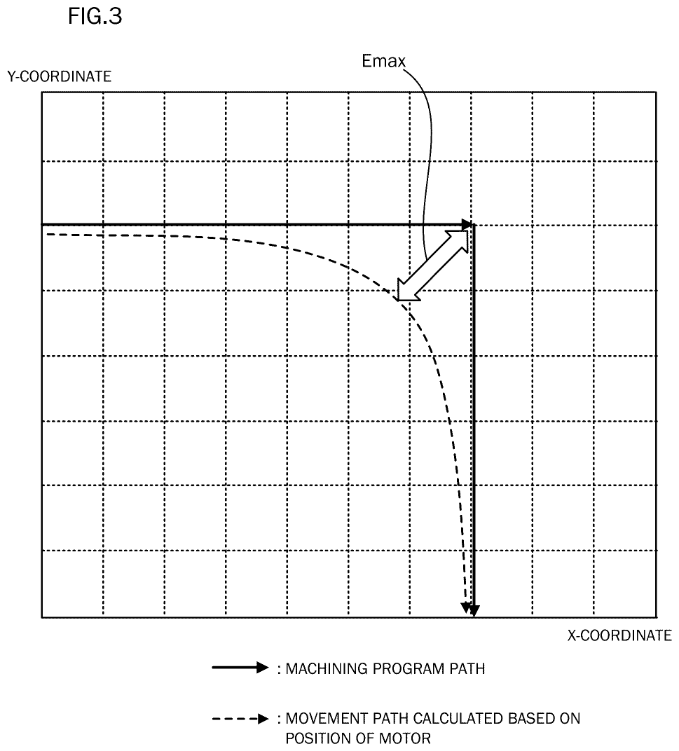

With reference to FIG. 3, a description will be given of calculation examples of the machining accuracy (shape error) and the machined surface quality (positional deviation) by the state observer 110. FIG. 3 illustrates a machining program path commanded by a machining program executed in the machine tool 3, and a movement path calculated based on a position of a motor. In FIG. 3, a horizontal axis indicates X-coordinate position, and a vertical axis indicates Y-coordinate position. Further, a solid line arrow indicates the machining program path commanded by the machining program, and a dotted line arrow indicates the movement path calculated based on the position of the motor. In machining by the machine tool 3, a movement command which is output with respect to a motor of each shaft along the machining program path commanded by the machining program is calculated based on a parameter related to control of the amount of movement for each control cycle, including the N-order time differential element (N being a natural number) of each shaft. In this calculation, a movement command that gives priority to a machining speed, efficiency, or the like is calculated within a set parameter range. For this reason, when the motor is moved based on the calculated movement path, the movement path calculated based on the position of the motor (a relative movement path between a tool driven by the motor and a workpiece) does not become the same as the machining program path. The state observer 110 calculates a shape error indicating machining accuracy and a positional deviation indicating machined surface quality, based on a difference between this machining program path and the movement path calculated based on the position of the motor. For example, a maximum value Emax of the shape error may be used as the shape error. In addition, an average value Means, a variance value Edisto, or the like may be used as the positional deviation.

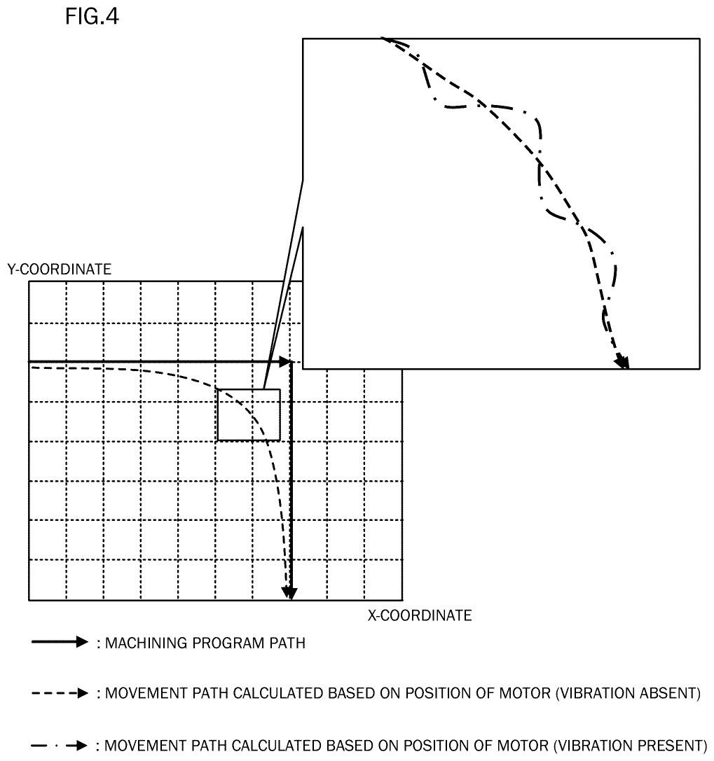

An example of calculating machined surface quality (vibration error) by the state observer 110 will be described with reference to FIG. 4. FIG. 4 illustrates the machining program path commanded by the machining program executed in the machine tool 3 and the movement path (vibration present or absent) calculated based on the position of the motor. When the path calculated based on the position of the motor is more closely examined, position data of the motor vibrates. This vibration appears as scratches or streaks during machining, and thus affects the machined surface quality. The state observer 110 calculates a vibration error indicating the machined surface quality based on a difference between a movement command output to the motor and a position acquired from the motor. As the vibration error, for example, a maximum value Amax of amplitude may be used, or an average value A mean of amplitude may be used.

Note that, when a vibration measuring device can be prepared as the sensor 4, the vibration error may be calculated using vibration data from the vibration measuring device in addition to the position data of the motor. In the vibration data from the vibration measuring device, it is possible to obtain vibration closer to a machining point (contact position between the tool and the workpiece).

The state observer 110 may directly acquire data from the machine tool 3 via the network 5. The state observer 110 may acquire data acquired and stored by the external device 72, the fog computer 6, the cloud server 7, etc. The data acquired or calculated by the state observer 110 is input to the learner 130 and the decision maker 140.

The determination condition acquirer 120 acquires determination data related to a machining purpose in machining by the machine tool 3. Examples of the determination data related to the machining purpose include a permissible value related to the machining accuracy or the machined surface quality such as predetermined permissible machining accuracy (permissible shape error), permissible machined surface quality (permissible positional deviation), and permissible machined surface quality (permissible vibration error). In addition, examples of the determination data related to the machining purpose include a target machining time. The determination condition acquirer 120 may acquire the permissible value related to the machining accuracy or the machined surface quality set in the machine tool 3 via the network 5. The determination condition acquirer 120 may acquire data stored by the external device 72, the fog computer 6, the cloud server 7, etc. The determination condition acquirer 120 may prompt the operator to input the permissible value related to the machining accuracy or the machined surface quality, and the target machining time from the input device 71. The data acquired by the determination condition acquirer 120 is input to the learner 130 and the decision maker 140.

The learner 130 executes processing related to machine learning based on the data indicating the operating state of machining by the machine tool 3 acquired by the state observer 110 and the determination data related to the machining purpose acquired by the determination condition acquirer 120. The learner 130 includes a reward calculation unit 132 and a value function update unit 134. The learner 130 updates a value function using the value function update unit 134 based on a reward calculated by the reward calculation unit 132, thereby learning a correlation between a combination of parameters related to control of the amount of movement for each control cycle, including an N-order time differential element (N being a natural number) of each shaft and a value of the combination.

The reward calculation unit 132 calculates a reward for a current operating state of the machine tool 3 based on the data indicating the operating state of machining by the machine tool 3 and the determination data related to the machining purpose. The reward calculation unit 132 compares a value indicating the machining accuracy or the machined surface quality calculated by the state observer 110 with the determination data related to the machining purpose, and calculates a reward using a predetermined reward calculation formula set in advance based on a result of comparison. A permissible value related to the machining accuracy or the machined surface quality is included in the determination data related to the machining purpose. The reward calculation unit 132 calculates a high reward when the calculated value indicating the machining accuracy or the machined surface quality falls within the permissible value. In addition, the reward calculation unit 132 calculates a low reward when the calculated value indicating the machining accuracy or the machined surface quality exceeds the permissible value. The reward calculation unit 132 may calculate a higher reward according to a degree of falling within the permissible value. In addition, the reward calculation unit 132 may calculate a lower reward according to a degree of exceeding the permissible value. The reward calculation unit 132 may calculate a negative reward.

The reward calculation unit 132 further compares a value indicating a machining time consumed for machining in the machine tool 3 with a target machining time included in the determination data related to the machining purpose, and calculates an additional reward using a predetermined reward calculation formula set in advance based on the comparison result. The reward calculation unit 132 calculates a high reward when the machining time consumed for machining falls within the target machining time. In addition, the reward calculation unit 132 calculates a low reward when the machining time consumed for machining exceeds the target machining time. The reward calculation unit 132 may calculate a higher reward according to a degree of falling within the machining time consumed for machining. In addition, the reward calculation unit 132 may calculate a lower reward according to a degree of exceeding the machining time consumed for machining. The reward calculation unit 132 may calculate a negative reward. The reward calculation unit 132 adds the additional reward calculated in this way to a reward calculated based on the machining accuracy or the machined surface quality.

Note that, when the machining time is considered as a reward, the reward calculation unit 132 may store machining times when the machining accuracy or the machined surface quality falls within the permissible value. At this time, among the stored machining times, the shortest machining time is used as the determination data related to the machining purpose. Then, only when the machining accuracy or the machined surface quality is within the permissible value, the reward calculation unit 132 calculates a reward after setting the machining time in that case and the stored shortest machining time as a basis for reward calculation. In this way, it becomes possible to search for a parameter that minimizes the machining time within a range of the target machining accuracy or machined surface quality.

The value function update unit 134 updates the value function stored in the value function storage unit 138 based on the reward calculated by the reward calculation unit 132. The value function used in the invention is a state value function that sets a combination of parameters related to control of the amount of movement for each control cycle, including the N-order time differential element (N being a natural number) of each shaft set during machining of the machine tool 3 as a state and calculates a value of currently being in the state. For example, the state value function V in the present embodiment may be defined as a function that returns a reward calculated by the reward calculation unit 132 as a value when machining is performed by taking each state (a combination of parameters related to control of the amount of movement for each control cycle, including the N-order time differential element (N being a natural number) of each shaft set). Note that it is preferable that the state value function outputs high values for all possible states at a stage when learning is started. The state value function may be constructed as a multilayer neural network, or the like that sets a combination of parameters related to control of the amount of movement for each control cycle, including the N-order time differential element (N being a natural number) of each shaft set during machining of the machine tool 3 as input data and sets a value of a state of the combination of the parameters as output data.

The decision maker 140 outputs the combination of parameters related to control of the amount of movement for each control cycle, including the N-order time differential element (N being a natural number) of each shaft based on the value function generated by the learner 130 performing machine learning. The decision maker 140 uses the value function to obtain a combination of parameters having a higher value with respect to a combination of parameters set in currently performed machining. For example, the decision maker 140 compares a value calculated from a combination of currently set parameters with a value calculated from a combination of parameters when each parameter is changed by a predetermined amount set in advance. For example, a value is calculated using a value function for each of a combination of currently set parameters, a combination of parameters obtained by changing linear acceleration by +AA, a combination of parameters obtained by changing linear acceleration by −ΔA, a combination of parameters obtained by changing a post-interpolation acceleration/deceleration time constant by +Δt, a combination of parameters obtained by changing a post-interpolation acceleration/deceleration time constant by −Δt, etc., and a combination of parameters having a higher value is obtained. Then, the obtained combination of parameters is output as a combination of parameters more suitable for current machining. At this time, when a value calculated from the combination of the currently set parameters is a highest value, the decision maker 140 may output the combination of current parameters as a combination of parameters having a higher value. When there is a combination of parameters of the same value, the decision maker 140 may randomly output a combination from combinations of parameters other than those currently set. At an initial state of learning by the learner 130, the decision maker 140 preferably outputs a random combination of parameters at a certain probability regardless of a value calculated by the value function (8-greedy method). In this way, it is possible to efficiently search for a more appropriate combination of parameters.

The action output unit 150 determines whether to continue parameter adjustment based on the combination of parameters output by the decision maker 140. Then, when it is determined to continue parameter adjustment, a command is given to set the combination of parameters output by the decision maker 140 with respect to the machine tool 3, and to perform a machining operation again. For example, when the combination of parameters output by the decision maker 140 is different from the combination of parameters currently set in the machine tool 3, the action output unit 150 may determine to continue parameter adjustment. In addition, the action output unit 150 may record the number of times that the parameters of the machine tool 3 are changed after parameter adjustment starts, and determine to continue parameter adjustment when the number of times that the parameters are changed is within a predetermined number of times set in advance.

The action output unit 150 may directly set a combination of parameters with respect to the machine tool 3 via the network 5. In addition, the action output unit 150 may transmit the combination of parameters via the network 5 to the fog computer 6 and the cloud server 7, and indirectly prompt the machine tool 3 to set the parameters. Furthermore, the action output unit 150 may display the combination of parameters on the display device 70, and prompt the operator to perform setting in the machine tool 3.

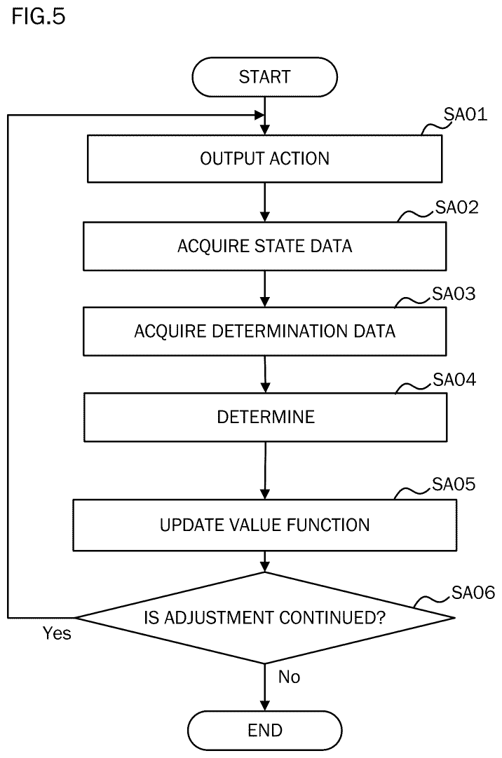

FIG. 5 is a flowchart illustrating processing when a combination of parameters is obtained using the acceleration/deceleration adjustment device 1 having the above configuration. When adjustment of a parameter related to control of the amount of movement for each control cycle, including the N-order time differential element (N being a natural number) of each shaft is commanded from the operator, etc., the acceleration/deceleration adjustment device 1 first sets a combination of parameters set in advance by the operator or the like (for example, linear acceleration 4000 mm/sec², corner speed difference 800 mm/min, or post-interpolation acceleration/deceleration time constant 32 msec) with respect to the machine tool 3. Then, the machine tool 3 is commanded to perform idle operation according to a predetermined machining program given in advance (step SA01).

While the machine tool 3 is performing idle operation of the machining program in response to this command, the state observer 110 acquires data indicating the operating state of the machine tool 3 (time-series data of the motor, time-series data of a motor speed, a machining time, etc.) (step SA02). Then, based on the acquired data indicating the operating state of the machine tool 3, data related to the machining accuracy and the machined surface quality (for example, machining accuracy (shape error) of 80 μm, machined surface quality (positional deviation) of 8 μm, and machined surface quality (vibration error) of 0.09 μm) is calculated (step SA02). In addition, the determination condition acquirer 120 acquires determination data related to the machining purpose in machining by the machine tool 3 (machining accuracy (permissible shape error) of 100 μm, machined surface quality (permissible positional deviation) of 10 μm, machined surface quality (permissible vibration error) of 0.1 μm, permissible machining time of 12.0 sec, etc.) (step SA03).

The reward calculation unit 132 calculates a reward for a combination of current parameters based on the data related to the machining accuracy or the machined surface quality input from the state observer 110 and the determination data related to the machining purpose input from the determination condition acquirer 120 (step SA04). Then, based on the calculated reward, the value function update unit 134 updates the value function stored in the value function storage unit 138 (step SA05).

The decision maker 140 obtains a combination of parameters considered more appropriate for current machining based on the updated value function, and outputs the obtained combination of parameters. The action output unit 150 receiving this input determines whether or not to continue parameter adjustment, sets the combination of parameters output by the decision maker 140 with respect to the machine tool 3 when the action output unit 150 determines to continue parameter adjustment, and gives a command to perform idle operation again according to the machining program using the set parameters (step SA06).

The acceleration/deceleration adjustment device 1 having the above configuration can quantitatively control a parameter more suitable for the machining accuracy/machined surface quality by setting a target value (shape error, positional deviation, etc.) of actual machining accuracy or machined surface quality. By quantitatively controlling a combination of set values of parameters, it is possible to maintain a combination of set values of parameters each suitable for a predetermined machining purpose, and to switch therebetween as appropriate according to the machining purpose. Furthermore, optimization of the combination of set values of parameters by the acceleration/deceleration adjustment device 1 according to the present embodiment can be performed while observing the environment (controller and machine tool) from the outside thereof. For this reason, there is no need to install new software or the like on the side where the environment is arranged, and usage in a wide range of environments is allowed.

Even though the embodiments of the invention have been described above, the invention is not limited to the above-described examples of the embodiments, and can be implemented in various modes by adding appropriate modifications.

For example, even though evaluation of the machining accuracy or the machined surface quality is performed based on a predetermined reward calculation formula set in advance in the above embodiments, it is possible to adopt a configuration in which an evaluation program related to evaluation can be registered from the outside. By adopting such a configuration, even when content of machining is changed, and a parameter desired to be learned is added, the machining accuracy and the machined surface quality can be efficiently evaluated by providing a dedicated evaluation program for square corners, R-corners, etc.

It is possible to adopt a configuration in which a range of each parameter output by the decision maker 140 can be set in advance. By adopting such a configuration, it is possible to limit a search range of parameters.

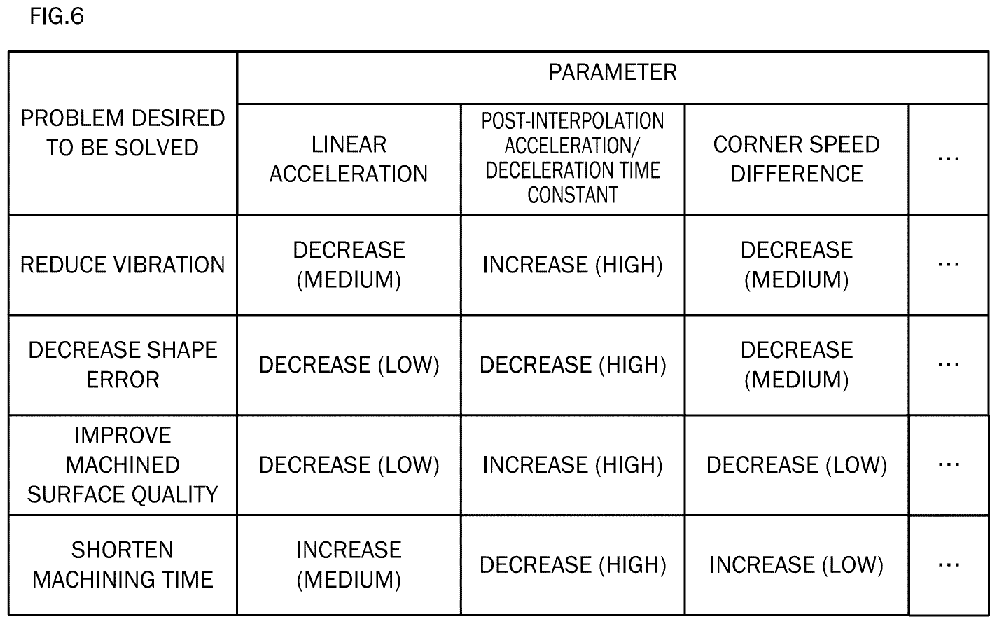

In the above-described embodiments, the decision maker 140 determines a combination of parameters to be output based on a value output by the value function. However, for example, a combination of generated parameters may be output by adjusting a parameter considered more appropriate according to a rule set in advance. For a problem to be solved, which is identified from a machining result, FIG. 6 illustrates parameter adjustment directions for solving the problem and priorities thereof in a table. In this way, by storing a relationship between the problem to be solved and a parameter adjustment method as a rule, the decision maker 140 can refer to the rule and determine a parameter to be adjusted.

It is possible to adopt a configuration in which a reward related to the machining accuracy or the machined surface quality calculated by the reward calculation unit 132 and an additional reward related to the machining time are weighted. By adopting such a configuration, it is possible to perform fine adjustment according to a machining purpose such that a weight of the reward related to the machining accuracy or the machined surface quality is increased when the machining quality is emphasized, while a weight of the reward related to the machining time is increased when the machining time is emphasized.

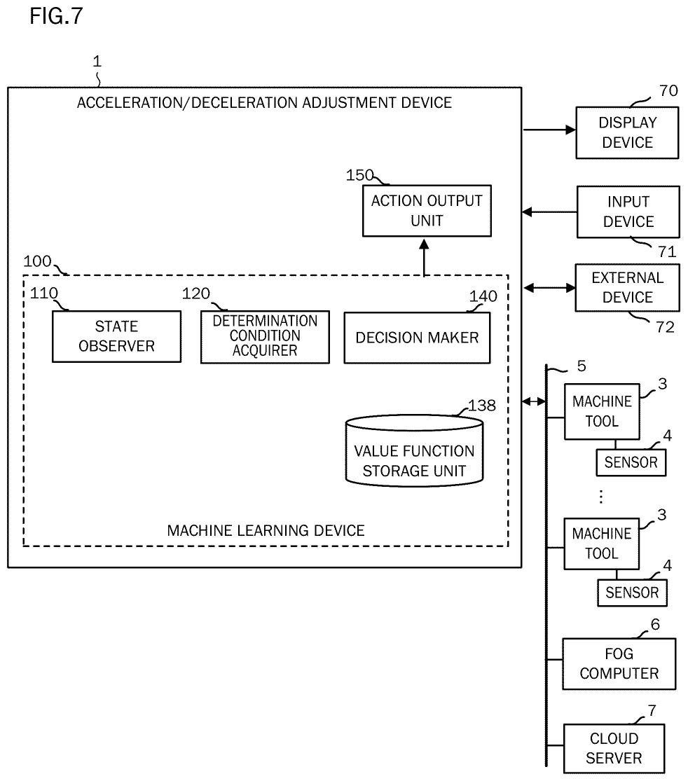

The above embodiments illustrate a configuration in which a parameter is adjusted while performing machine learning by the learner 130. However, after learning by the learner 130 is sufficiently performed, the learner 130 may be eliminated from the acceleration/deceleration adjustment device 1 while leaving the value function storage unit 138. FIG. 7 illustrates a configuration example when the learner 130 is eliminated. By adopting such a configuration, the value function is not updated. However, by giving an initial parameter to the acceleration/deceleration adjustment device 1, the decision maker 140 searches for a more appropriate parameter, a parameter of the machine tool 3 can be adjusted.

### EXPLANATIONS OF REFERENCES

1 ACCELERATION/DECELERATION ADJUSTMENT DEVICE
3 MACHINE TOOL
4 SENSOR
5 NETWORK
6 FOG COMPUTER
7 CLOUD SERVER
11 CPU
12 ROM
13 RAM
14 NONVOLATILE MEMORY
15 INTERFACE
17, 18, 20, 21 INTERFACE
22 BUS
70 DISPLAY DEVICE
71 INPUT DEVICE
72 EXTERNAL DEVICE
100 MACHINE LEARNING DEVICE
101 PROCESSOR
102 ROM
103 RAM
104 NONVOLATILE MEMORY
110 STATE OBSERVER
120 DETERMINATION CONDITION ACQUIRER
130 LEARNER
132 REWARD CALCULATION UNIT
134 VALUE FUNCTION UPDATE UNIT
138 VALUE FUNCTION STORAGE UNIT
140 DECISION MAKER
150 ACTION OUTPUT UNIT

1. A machine learning device for estimating parameters related to control of an amount of movement for each control cycle, including an N-order time differential element (N being a natural number) of each shaft included in a machine tool for performing machining of a workpiece, the machine learning device comprising:
a state observer configured to observe information related to at least one of machining accuracy or machined surface quality in the machining and a machining time consumed for the machining, as data indicating an operating state of the machine tool;
a determination condition acquirer configured to acquire a target value related to data observed by the state observer as determination data;
a reward calculation unit configured to calculate a reward for machining based on the parameters based on data observed by the state observer and the determination data acquired by the determination condition acquirer;
a value function update unit configured to update a value function for calculating a value of a machining state based on the parameters based on the reward; and
a decision maker configured to estimate a combination of set values of the parameters more suitable for the machining based on the updated value function, and output the estimated combination of the set values of the parameters.

2. The machine learning device according to claim 1, wherein an evaluation program capable of evaluating at least one of the machining accuracy and the machined surface quality is allowed to be registered, and a reward related to at least one of the machining accuracy and the machined surface quality is calculated using the evaluation program.

3. The machine learning device according to claim 1, wherein the decision maker estimates a combination of set values of the parameters more shortening a machining time in the machining and more suitable for the machining based on the updated value function, and outputs the estimated combination of the set values of the parameters.

4. An acceleration/deceleration adjustment device for adjusting parameters related to control of an amount of movement for each control cycle, including an N-order time differential element (N being a natural number) of each shaft included in a machine tool for performing machining of a workpiece, the acceleration/deceleration adjustment device comprising:
a state observer configured to observe information related to at least one of machining accuracy or machined surface quality in the machining and a machining time consumed for the machining as data indicating an operating state of the machine tool;
a determination condition acquirer configured to acquire a target value related to data observed by the state observer as determination data;
a value function storage unit configured to store a value function for calculating a value of a machining state based on the parameters;
a decision maker configured to estimate a combination of set values of the parameters more suitable for the machining based on the value function, and output the estimated combination of the set values of the parameters; and
an action output unit configured to adjust the parameters of the machine tool based on a combination of set values of the parameters output by the decision maker.

5. The acceleration/deceleration adjustment device according to claim 4, wherein the determination condition acquirer is allowed to set a plurality of target values.

6. The acceleration/deceleration adjustment device according to claim 4, wherein a range of set values of the parameters output by the decision maker is allowed to be set.

7. The acceleration/deceleration adjustment device according to claim 4, wherein a number of times that the parameters are adjusted is allowed to be set.

8. A computer-readable storage medium storing a program causing a computer to operate as a machine learning device for estimating parameters related to control of an amount of movement for each control cycle, including an N-order time differential element (N being a natural number) of each shaft included in a machine tool for performing machining of a workpiece, the computer-readable storage medium storing a program causing the computer to operate as:
a state observer configured to observe information related to at least one of machining accuracy or machined surface quality in the machining and a machining time consumed for the machining as data indicating an operating state of the machine tool;
a determination condition acquirer configured to acquire a target value related to data observed by the state observer as determination data;
a reward calculation unit configured to calculate a reward for machining based on the parameters based on data observed by the state observer and the determination data acquired by the determination condition acquirer;
a value function update unit configured to update a value function for calculating a value of a machining state based on the parameters based on the reward; and
a decision maker configured to estimate a combination of set values of the parameters more suitable for the machining based on the updated value function, and output the estimated combination of the set values of the parameters.

9. A computer-readable storage medium storing a program causing a computer to operate as an acceleration/deceleration adjustment device for adjusting parameters related to control of an amount of movement for each control cycle, including an N-order time differential element (N being a natural number) of each shaft included in a machine tool for performing machining of a workpiece, the computer-readable storage medium storing a program causing the computer to operate as:
a state observer configured to observe information related to at least one of machining accuracy or machined surface quality in the machining and a machining time consumed for the machining as data indicating an operating state of the machine tool;
a determination condition acquirer configured to acquire a target value related to data observed by the state observer as determination data;
a value function storage unit configured to store a value function for calculating a value of a machining state based on the parameters;
a decision maker configured to estimate a combination of set values of the parameters more suitable for the machining based on the value function, and output the estimated combination of the set values of the parameters; and
an action output unit configured to adjust the parameters of the machine tool based on a combination of set values of the parameters output by the decision maker.
